(19) United States
(12) Patent Application Publication
(10) Pub. No.: US 2013/0059143 A1
(43) Pub. Date: Mar. 7, 2013

(54) GRAPHENE BASED CONDUCTIVE MATERIAL AND PREPARATION METHOD THEREOF

(71) Applicants: Minghui Liang, Beijing (CN); Linjie Zhi, Beijing (CN)

(72) Inventors: Minghui Liang, Beijing (CN); Linjie Zhi, Beijing (CN)

(73) Assignee: NATIONAL CENTER FOR NANOSCIENCE AND TECHNOLOGY, Beijing (CN)

(21) Appl. No.: 13/698,517

(22) PCT Filed: May 16, 2011
(86) PCT No.: PCT/CN2011/074117

§ 371 Date: Nov. 16, 2012

(30) Foreign Application Priority Data
May 18, 2010 (CN) 201010179290.2

(51) Int. Cl. H01B 1/04; C01B 31/00; B05D 5/12; B32B 9/00; B82Y 40/00; B82Y 30/00

(52) U.S. Cl. 428/220; 427/113; 428/339; 428/332; 423/448; 977/734; 977/842

(57) ABSTRACT

A method for preparing a graphene based conductive material and the graphene based conductive material prepared by the method. The method includes: preparing a solid film on a substrate layer by using graphene oxide sol and metal salt solution and/or metal colloidal solution, keeping the solid film separated or without separated from the substrate layer standing for from 30 s to 10000 h in an atmosphere consisting of hydrogen or containing hydrogen with temperature of −50° C.˜200° C. and hydrogen pressure of 0.01-100 MPa, obtaining the graphene based conductive material. The preparation method can be processed at low temperature and uses cheap hydrogen as reductant, so the preparation process is simple and environment friendly.

### FIELD OF THE INVENTION

The present invention relates to a method for preparing graphene based conductive material, and the graphene based conductive material prepared by the method.

### BACKGROUND OF THE INVENTION

Graphene is a one-atom-thick two-dimension sheet composed of hexagonally arrayed sp² carbon atoms. It is the building block of graphite. People discovered that graphene has many properties that graphite does exhibited, for example: Room-Temperature Quantum Hall Effect, mimicmass transfer characteristics, optical properties, thermoelectric transport properties, light transmittance and extremely high Young modulus. Owing to these properties of graphene, graphene and graphene based material have potential use in many aspects, such as: display films, solar cell electrodes, lithium ion battery electrodes, field effect transistors and sensors.

Usually, mass production of graphene material is realized by reducing graphene oxide (GO). GO is produced from graphite by oxidizing graphite, which comprises carbon, hydrogen and oxygen. After graphite is oxidized, not only defects are generated but also its original planar structure is destroyed. After reduction treatment of GO, the proportion of oxygen in it decreases, the lamellar structure of graphene is restored and so is its electrical conductivity. The graphene products obtained with different reductive methods have remarkable difference, which is mainly reflected in structure and composition. The presently used GO reduction methods mainly include high-temperature thermal treatment, hydrazine reduction and sodium borohydride reduction, and so on. On the one hand, the graphene obtained with these methods has large difference in composition and structure. By thermal treatment, some oxygen-containing functional groups are removed, but the defects more serious than oxidation process are generated. Some research reports indicate that after thermal treatment, its internal structure is reformed and five-membered rings, seven-membered rings, eight-membered rings and even more complex carbon structures are formed, which have much difference with the six-membered rings of graphene in structure. Literature study indicates that treated by hydrazine or sodium borohydride, the obtained graphene contains nitrogen or boron and these nitrogen atoms or boron atoms form chemical bonds with the carbon atoms of the graphene obtained by reduction. Therefore, the graphene obtained by reducing GO using the two reducing reagents is in fact the graphene chemically doped with nitrogen or boron. These two types of graphene may be called as nitrogen-doped graphene and boron-doped graphene. On the other hand, these currently adopted methods have many defects. For example, high temperature causes the difficulty in the deposition of graphene onto a flexible substrate, the reducing reagent hydrazine is toxic, and sodium borohydride is too expensive. Hydrogen is also a reductant, and may be used to reduce GO, but the reduction by hydrogen alone requires high temperature. For instance, it is reported in literature that using hydrogen at 1000° C. to reduce GO. As experienced thermal treatment, the efficiency of hydrogen reduction becomes very limited.

The catalyst of metal Pd loaded on GO has been reported in literature, but the material containing graphene and metal only was used as catalysts in organic reaction. The literature did not mention whether the material is electrically conductive. Besides, the obtained graphene is reduced by hydrazine, so the graphene contains nitrogen. It is also reported in literature that sodium borohydride reduces GO and Pd coordination compound to obtain a material containing graphene and metal Pd, but the graphene contains boron. Therefore, no existing patents and literatures report that a solid graphene based conductive material containing metal being obtained by reducing GO with hydrogen.

### SUMMARY OF THE INVENTION

In order to overcome the defect of the prior art that high temperature or toxic hydrazine needs to be used during preparation of a graphene material, the present invention provides a graphene based conductive material that can be prepared at low temperature and is environment friendly and pollution free, and preparation method thereof as well.

The inventor of the present invention discovered that introduced metal can play a role of catalyzing the GO reduction process at relatively low reaction temperature. Based on this discovery, the inventor provides a method for directly preparing a solid graphene based conductive material at low temperature and the solid graphene based conductive material prepared by the method.

The present invention provides a method for preparing a graphene based conductive material. The method includes: preparing a solid film on a substrate layer by using graphene oxide sol and metal salt solution and/or metal colloidal solution, keeping the solid film separated or without separated from the substrate layer standing for from 30 s to 10000 h in an atmosphere consisting of hydrogen or containing hydrogen at temperature of −50° C.˜200° C. under hydrogen pressure of 0.01-100 MPa, obtaining the graphene based conductive material.

The present invention also provides a graphene based conductive material, which are prepared by the above method.

Compared with the prior art, the method provided by the present invention has the following beneficial effects:
(1) For the first time, the present invention prepares a graphene based conductive material by a method of catalytic hydrogenation reduction of solid GO. The method uses catalyst to lower the temperature of hydrogenation reduction reaction of GO. As hydrogen at low temperature is used to reduce GO, the skeleton structure of GO is not destroyed, so it is different from the GO treated at high temperature, which has many defects. Moreover, it does not introduce hetero atoms and is different from the graphene obtained through reduction of hydrazine or sodium borohydride in terms of composition. Further, as the temperature of hydrogenation reduction reaction is lowered, a graphene based conductive material may be prepared at room temperature on some polymer substrates which can not endure high-temperature treatment.
(2) The graphene obtained through hydrogen reduction of GO in a solution is not solid and does not form a conductive material. The method provided by the present invention may overcome the complex process that graphene precipitate or particles are prepared in a solution and then processed into a molded conductive material. Its operation is simple. Therefore, this method may be used in mass production of a graphene based conductive material.
(3) The present invention prepares a graphene based conductive material by a method of catalytic hydrogenation reduction of GO. Relative to the reduction route using toxic hydrazine, the present invention provides a green reduction route. Relative to the reduction route using expensive sodium borohydride and benzoquinone, the hydrogen used in the present invention is a cheap and easily available raw material.
(4) The graphene based conductive material prepared in the present invention has high chemical stability and thermal stability and can be loaded on a flexible substrate, so it may be widely applied in flexible devices, such as: flexible circuits, flexible transparent window electrodes and flexible touch screen electrodes.

### BRIEF DESCRIPTION OF THE DRAWINGS

FIG. 1 is a graphene based conductive film on flexible substrate PET obtained according to Example 2 of the present invention.

FIG. 2 is a stand-alone graphene conductive film obtained according to Example 4 of the present invention.

FIG. 3 is a graphene conductive film obtained according to Example 12 of the present invention, which is on printing paper and has a specific pattern.

### DETAILED DESCRIPTION OF THE EMBODIMENTS

The present invention provides a method for preparing a graphene based conductive material. The method includes: preparing a solid film on a substrate layer by using graphene oxide (GO) sol and metal salt solution and/or metal colloidal solution, keeping the solid film separated or without separated from the substrate layer standing for from 30 s to 10000 h in an atmosphere consisting of hydrogen or containing hydrogen at temperature of −50° C.˜200° C. under hydrogen pressure of 0.01-100 MPa, obtaining the graphene based conductive material.

According to the present invention, preferably, the time of standing is from 5 min to 300 h and more preferably, the time of standing is from 2 h to 5 days.

According to the present invention, preferably, the hydrogen pressure is 0.2-100 MPa.

According to the present invention, under particularly preferred condition, the temperature is 20-120° C., the hydrogen pressure is 1-15 Mpa and the reaction time may be from 2 h to 5 days.

In the present invention, when it is a hydrogen atmosphere (that is reductive atmosphere consisting of hydrogen), the hydrogen pressure is gauge pressure; when it is a hydrogen-containing reductive atmosphere (that is reductive atmosphere containing hydrogen), such as: an atmosphere of a mixture of hydrogen and nitrogen and/or inert gas, the hydrogen pressure is hydrogen partial pressure. Apparently, the preparation method of the present invention may prepare a graphene based conductive material at low temperature, such as room temperature in a convenient manner.

In the method provided by the present invention for preparing a graphene based conductive material, by controlling the doses of GO and metal salt solution and/or metal colloidal solution, the ratio between the metal atoms in the graphene based conductive material and the carbon atoms in the graphene can be controlled at 0.0001-0.13. The diameter of the colloidal particles in the metal colloidal solution is 0.7-10 nm, the concentration of the GO sol is 0.5-2 g/L, the concentration of the metal salt solution is 1-3 g/L, and the concentration of the metallic colloid is 3-7 g/L. Meanwhile, by introducing a small amount of metal salt solution and/or metal colloidal solution, the purpose of catalytic hydrogenation may be realized, so using precious metal or its salt as catalyst or catalyst precursor can reduce the consumption of precious metal. Besides, when metal salt is used as catalyst in the preparation process, the metal salt is reduced into metal particles in the reduction reaction at first and then the metal particles catalyze the reduction of GO by hydrogen.

The metal in the metal salt solution and/or metal colloidal solution is one or more selected from the group consisting of palladium, platinum, rhodium, ruthenium, osmium, iridium and nickel. The metal salt is one or more selected from the group consisting of nitrate, hydrochloride, sulfate, phosphate, oxalate, acetate, formate, propionate, butyrate and valerate. The solvent of the metal salt solution is one or more selected from the group consisting of water, C1-C4 low alcohols, acetone and dimethyl formamide (DMF). The solvent of the GO sol is one or more selected from the group consisting of water, C1-C4 low alcohols and acetone.

In the present invention, the method for preparing a solid film on a substrate layer by using graphene oxide sol and metal salt solution and/or metal colloidal solution includes one or more processes selected from the group consisting of spin coating process, droplet coating process, spray coating process, inkjet printing process and a process of heating the liquid films into solid films.

In the present invention, the material of the substrate layer is one of glass sheet, quartz sheet, silicon slice, silicon carbide sheet, fibrous flexible material, natural flexible ore material and polymer membrane. The polymer membrane is a transparent film made from polyethylene terephthalate (PET), polyethylene (PE), polypropylene (PP), polystyrene (PS) or polyvinyl chloride (PVC). The fibrous flexible material is printing paper. The natural flexible ore material is mica sheet.

In the method provided by the present invention for preparing a graphene based conductive material, by controlling the occurrence conditions of catalytic hydrogenation reduction reaction of GO, such as: reaction time, and thickness and size of the solid substance, different graphene based conductive material may be obtained. For example, when the thickness of the conductive graphene material obtained after reduction by controlling the film thickness of the mixture of GO hydrosol and metal salt solution and/or metal colloidal solution is 1-100 nm, the obtained graphene based conductive material has excellent light transmittance; when the thickness of the conductive graphene material obtained after reduction by controlling the film thickness of the mixture of GO hydrosol and metal salt solution and/or metal colloidal solution is 100 nm-1 mm, the obtained graphene based conductive material has excellent electrical conductivity.

The GO may be prepared by various methods known in the art, which include Staudenmaier, Brodie and Hummers method. Staudenmaier method adopts the mixture of concentrated sulfuric acid and fuming nitric acid as a solvent and an oxidant, and potassium chlorate as an oxidant and uses graphite as a raw material to prepare graphite oxide. Brodie method adopts fuming nitric acid as a solvent and an oxidant, and potassium chlorate as an oxidant and uses graphite as a raw material to prepare graphite oxide. Hummers method adopts concentrated sulfuric acid as a solvent and an oxidant, and sodium nitrate and potassium permanganate as oxidants. Alternatively, other methods modified on the basis of these methods may be adopted, too.

Preferably, GO in the present invention may be prepared by the following steps, but its preparation is not limited to the following method:
(1) Flaky graphite is oxidized in a mixed oxidant of concentrated sulfuric acid and potassium permanganate and treated by hydrogen peroxide.
(2) The mixture obtained after the oxidation is washed, filtered and centrifugally separated to obtain GO.

In an embodiment of the present invention, the GO preparation method is as follows: About 1 g of natural flaky graphite is added to 20-100 g of concentrated sulfuric acid. They are stirred and kept overnight in a 0° C. ice bath. Then 0.05-0.5 g of potassium permanganate is added to the obtained mixture. In order to prevent temperature rise, after 10-100 min's stirring, 1-10 g of potassium permanganate is added and the temperature is controlled below 20° C. Then the temperature is raised to 20-50° C. and kept 10-100 min. In this process, the obtained mixture becomes sticky. Then 20-100 ml of water is added to this mixture and the temperature is raised to 90-95° C. and kept 15-60 min. Then 30-60 ml of 20-50 wt % hydrogen peroxide is added. After 10-100 min's stirring, 10-100 ml of water is added. The mixture is filtered while it is hot. The residue is washed with 20-100 ml of 1-10 wt % HCl. The obtained filter cake is put into 400-1000 ml of water and treated in ultrasound 0.5-2 h. The GO particles not thoroughly stripped are centrifugally removed from the obtained dispersion liquid (the particles not thoroughly stripped are attached to the inner wall of the centrifuge). A small amount of conglobate GO fine particles is centrifugally removed from the dispersion liquid obtained from centrifugal separation, to obtain jelly. About 500-2000 ml of water (or a mixed solution of ethanol and water, or a mixed solution of methanol and water (the range of the volume ratio between methanol or ethanol and water is 0.1-10) or DMF) is added to disperse the jelly, thus obtaining a colloidal solution of GO.

The present invention also provides a graphene based conductive material, which is prepared by the aforementioned method.

According to the present invention, the graphene based conductive material comprises a conductive layer. The conductive layer contains metal and graphene. The resistivity of the conductive layer is 0.01 Ω/sq-50 kΩ/sq, the light transmittance is 0-96% and the thickness is 1 nm-1 mm.

According to the present invention, preferably, the light transmittance is 0-90% and the thickness is 5 nm-1 mm.

According to the present invention, when the resistivity of the conductive layer is 100 Ω/sq-50 kΩ/sq, the light transmittance is 50-90% and the thickness is 1-100 nm, the conductive material can have both good electrical conductivity and good light transmittance. When the resistivity of the conductive layer is 0.01-100 Ω/sq and the thickness is 100 nm-1 mm, the conductive material has excellent electrical conductivity and may perfectly substitute metal as a conductive material in circuits. In the present invention, Ω/sq means ohm/square centimeter. In other words, the resistance in the present invention is square resistance.

In the present invention, on the basis of the total amount of the conductive layer, the content of graphene in the conductive layer is 60-99.999 wt % and the content of metal is 0.001-40 wt %.

The graphene based conductive material of the present invention may also contain water and impurities. Preferably, on the basis of the total amount of the conductive layer, the content of graphene in the conductive layer is 64-98 wt %, the content of metal is 1-15 wt %, and the total content of water and impurities is 0-35 wt %.

In the conductive material of the present invention, the metal is one or more selected from the group consisting of palladium, platinum, rhodium, ruthenium, osmium, iridium and nickel.

The graphene based conductive material of the present invention also comprises a substrate layer to which the conductive layer is attached. The material of the substrate layer is one of glass sheet, quartz sheet, silicon slice, silicon carbide sheet, fibrous flexible material, natural flexible ore material and polymer membrane. Preferably, the polymer membrane is a transparent film made from PET, PE, PP, PS or PVC, the fibrous flexible material is printing paper and the natural flexible ore material is mica sheet.

Now the present invention will be further described in connection with examples.

### Example 1

This example is intended to describe the preparation method of the graphene based conductive material of the present invention.
(1) Preparation of a GO colloidal solution: About 1 g of natural flaky graphite is added to 20 g of 95 wt % concentrated sulfuric acid. They are stirred and kept overnight in a 0° C. ice bath. Then 0.15 g of potassium permanganate is added to the obtained mixture. After 30 min's stirring, 3 g of potassium permanganate is added and the temperature is controlled below 20° C. Then the temperature is raised to 35° C. and kept 30 min. Then 45 ml of water is added to this mixture and the temperature is raised to 90-95° C. and kept 15 min. Then 30 ml of 30 wt % hydrogen peroxide is added. After 30 min's stirring, 26 ml of water is added. The mixture is filtered while it is hot. The residue is washed with 50 ml of 3 wt % hydrochloric acid (HCl) three times. The obtained filter cake is put into 400 ml of water and treated in ultrasound 1 h. The GO particles not thoroughly stripped are centrifugally removed from the obtained dispersion liquid at 3000 r/min (the particles not thoroughly stripped are attached to the inner wall of the centrifuge). A black GO dispersion liquid is obtained. A small amount of conglobate GO fine particles is centrifugally removed from the obtained dispersion liquid at 10000 r/min to obtain jelly. About 1000 ml of water is added to disperse the jelly, thus obtaining a colloidal solution of GO.
(2) Preparation of a conductive graphene material: 3 ml of palladium chloride (PdCl₂) aqueous solution (2 g/l as to Pd, Beijing Chemical Reagent Co., Ltd.) is added to 60 ml of the foregoing GO colloidal solution (containing about 60 mg of GO). 2 ml of the obtained mixed solution is dropwise added and evenly distributed (i.e.: droplet coating method) on a cleaned glass sheet (2 cm×2 cm). The sheet with the solution is dried in a drying oven at 80° C. to obtain a solid substance of GO and PdCl₂ on the glass sheet. The solid substance is put in an autoclave with a hydrogen atmosphere and reacts at 1 MPa hydrogen pressure and 25° C. 12 h to obtain a graphene based conductive material with conductive layer 2 μm thick. According to the calculation based on the added materials, in the graphene based conductive material, the ratio between the metal atoms in the conductive layer and the carbon atoms in the graphene is 0.020, the content of graphene is 83.1 wt %, the content of metal palladium is 15 wt % and the content of water and impurities is 1.9 wt %. The resistivity of the conductive layer of the obtained graphene based conductive material measured by a four-point-probe resistance tester (Guangzhou Four-Probe Instruments Co., Ltd., model: RTS-9 double-electrometric four-point-probe tester) is 10 Ω/sq, so the material can be used as a circuit material.

### Example 2

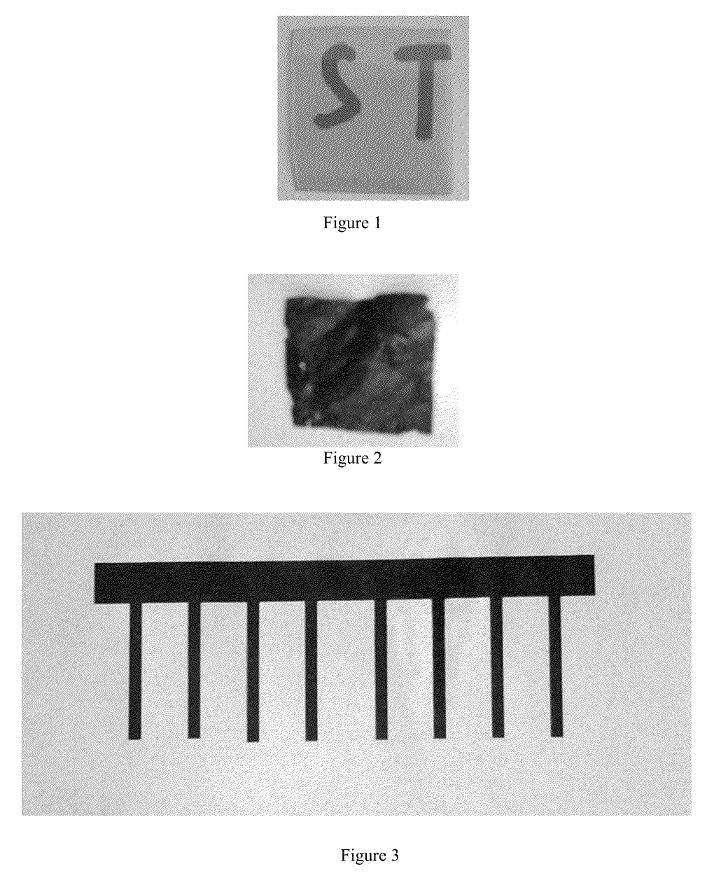

This example is intended to describe the preparation method of the graphene based conductive material of the present invention.
(1) Preparation of a GO colloidal solution: Same as Step (1) in Example 1.
(2) Preparation of a graphene based conductive material: 0.5 ml of PdCl₂ aqueous solution (2 g/l as to Pd, Beijing Chemical Reagent Co., Ltd.) is added to 60 ml of the GO colloidal solution obtained by the above Step (1) (containing about 60 mg of GO). 0.5 ml of the obtained mixed solution is dropwise added on a cleaned PET sheet (2 cm×2 cm) and spin coated with a spin coater (Institute of Electronics, Chinese Academy of Sciences, model: kW-4A) at 2000 r/min 60 s at room temperature to obtain a solid substance of GO and PdCl₂ on the PET sheet. The solid substance is put in an autoclave with a hydrogen atmosphere and reacts at 5 MPa hydrogen pressure and 25° C. 12 h to obtain a graphene based conductive material with conductive layer about 25 nm thick (refer to FIG. 1, which shows the obtained graphene based conductive material on a piece of white paper with black words. It indicates the graphene based conductive material has excellent light transmittance). According to the calculation based on the added materials, in the graphene based conductive material, the ratio between the metal atoms in the conductive layer and the carbon atoms in the GO is 0.002, the content of graphene is 95.5 wt %, the content of metal palladium is 3.0 wt % and the content of water and impurities is 1.5 wt %. The resistivity of the conductive layer of the obtained graphene based conductive material measured by a four-point-probe resistance tester (Guangzhou Four-Probe Instruments Co., Ltd., model: RTS-9 double-electrometric four-point-probe tester) is 1.2M/sq. The light transmittance at 550 nm is 72%. The graphene based conductive material has both light transmittance and electrical conductivity, so it may be used as a material of window electrodes.

### Example 3

This example is intended to describe the preparation method of the graphene based conductive material of the present invention.
(1) Preparation of a GO colloidal solution: Same as Step (1) in Example 1.
(2) Preparation of a graphene based conductive material: 0.03 ml of PdCl₂ aqueous solution (2 g/l as to Pd, Beijing Chemical Reagent Co., Ltd.) is pipetted with a pipettor and added to 600 ml of the GO colloidal solution obtained by the above Step (1) (containing about 600 mg of GO). 0.024 ml of the obtained mixed solution is sprayed on a cleaned PET sheet (10 cm×10 cm) with a sprayer (made in Germany, model: Leica EM SCD005). The sheet with the solution is dried in a drying oven at 80° C. to obtain a solid substance of GO and PdCl₂ on the PET sheet. The solid substance is put in an autoclave with a hydrogen atmosphere and reacts at 0.01 MPa hydrogen pressure and 120° C. 2 h to obtain a graphene based conductive material with conductive layer 1 nm thick. According to the calculation based on the added materials, in the graphene based conductive material, the ratio between the metal atoms in the conductive layer and the carbon atoms in the GO is 0.0001, the content of graphene is 99.999 wt % and the content of metal palladium is 0.001 wt %. The resistivity of the conductive layer of the obtained graphene based conductive material measured by a four-point-probe resistance tester (Guangzhou Four-Probe Instruments Co., Ltd., model: RTS-9 double-electrometric four-point-probe tester) is 50M/sq. The light transmittance at 550 nm is 96%. The graphene based conductive material has both light transmittance and electrical conductivity, so it can be used a material of window electrodes.

### Example 4

This example is intended to describe the preparation method of the graphene based conductive material of the present invention.
(1) Preparation of a GO colloidal solution: Same as Step (1) in Example 1.
(2) Preparation of a graphene based conductive material: 60 ml of the GO colloidal solution obtained by the above Step (1) (containing about 60 mg of GO) is measured and centrifuged at 10000 r/min to obtain a precipitate. The precipitate is dispersed in 60 ml of butanol. 107 ml of PdCl₂ butanol solution (2 g/l as to Pd, Beijing Chemical Reagent Co., Ltd.) is added to the obtained mixed solution. 7 ml of the obtained mixed solution is dropwise added to a culture dish (diameter 3.5 cm). The culture dish with the solution is heated dry at 120° C. to obtain a dry film. 3 wt % HF is added to disengage the dry film from the culture dish. The stand-alone film is taken out and dried again at 120° C. The dry film is put in an autoclave with a hydrogen atmosphere and reacts at 100 MPa hydrogen pressure and −50° C. 300 h to obtain a graphene based conductive material with conductive layer 1 μm an thick (refer to FIG. 2). According to the calculation based on the added materials, in the graphene based conductive material, the ratio between the metal atoms in the conductive layer and the carbon atoms in the GO is 0.05, the content of graphene is 60 wt % and the content of metal palladium is 40 wt %. The resistivity of the conductive layer of the obtained graphene based conductive material measured by a four-point-probe resistance tester (Guangzhou Four-Probe Instruments Co., Ltd., model: RTS-9 double-electrometric four-point-probe tester) is 40 Ω/sq, so the material can be used as a conductive material.

### Example 5

This example is intended to describe the preparation method of the graphene based conductive material of the present invention.
(1) Preparation of a GO colloidal solution: Same as Step (1) in Example 1.
(2) Preparation of graphene: 107 ml of nickel sulfate (NiSO₄) aqueous solution (2 g/l as to Ni, Beijing Chemical Reagent Co., Ltd., AR) is added to 600 ml of the GO colloidal solution obtained by the above Step (1) (containing about 600 mg of GO). 2 ml of the obtained mixed solution is dropwise added and evenly distributed on a quartz sheet (2 cm×2 cm). The sheet with the solution is heated dry at 200° C. Again 2 ml of the mixed solution is dropwise added and evenly distributed on this sample. This process is repeated 500 times to obtain a solid substance of GO and NiSO₄ on the quartz sheet. This solid substance is put in an autoclave with a hydrogen atmosphere and reacts at 15 MPa hydrogen pressure and 120° C. 120 h (5 d) and then dried to obtain a graphene based conductive material with conductive layer 1 mm thick. HF is used to disengage the film to obtain a stand-alone graphene film. According to the calculation based on the added materials, in the graphene based conductive material, the ratio between the metal atoms in the conductive layer and the carbon atoms in the GO is 0.13, the content of graphene is 60 wt % and the content of metal nickel is 40 wt %. The resistivity of the conductive layer of the obtained graphene based conductive material measured by a four-point-probe resistance tester (Guangzhou Four-Probe Instruments Co., Ltd., model: RTS-9 double-electrometric four-point-probe tester) is 0.01 Ω/sq.

### Example 6

This example is intended to describe the preparation method of the graphene based conductive material of the present invention.
(1) Preparation of a GO colloidal solution: Same as Step (1) in Example 1.
(2) Preparation of a graphene based conductive material: 1 ml of chloroplatinic acid aqueous solution (2 g/l as to Pt, Beijing Chemical Reagent Co., Ltd.) is added to 60 ml of the foregoing GO colloidal solution (containing about 60 mg of GO). 2.5 ml of the obtained mixed solution is dropwise added on a cleaned PET sheet (2 cm×2 cm) and spin coated with a spin coater (Institute of Electronics, Chinese Academy of Sciences, model: kW-4A) at 2000 r/min 60 s at room temperature to obtain a solid substance of GO and chloroplatinic acid on the PET sheet. This solid substance is put in an autoclave with a hydrogen atmosphere and reacts at 5 MPa hydrogen pressure and 25° C. 12 h to obtain a graphene based conductive material with conductive layer 100 nm thick. According to the calculation based on the added materials, in the graphene based conductive material, the ratio between the metal atoms in the conductive layer and the carbon atoms in the GO is 0.002, the content of graphene is 98 wt %, the content of metal platinum is 1 wt % and the content of water and impurities is 1 wt %. The resistivity of the conductive layer of the obtained graphene based conductive material measured by a four-point-probe resistance tester (Guangzhou Four-Probe Instruments Co., Ltd., model: RTS-9 double-electrometric four-point-probe tester) is 100 Ω/sq. The light transmittance at 550 nm is 50%. Therefore, the graphene based conductive material has both light transmittance and electrical conductivity and can be used a material of window electrodes.

### Example 7

This example is intended to describe the preparation method of the graphene based conductive material of the present invention.
(1) Preparation of a GO colloidal solution: Same as Step (1) in Example 1.
(2) Preparation of a graphene based conductive material: 10 ml of ruthenium nitrate aqueous solution (2 g/l as to ruthenium, Beijing Chemical Reagent Co., Ltd.) is added to 60 ml of the GO colloidal solution obtained by the above Step (1) (containing about 60 mg of GO). 0.5 ml of the obtained mixed solution is dropwise added on a cleaned PVC membrane (2 cm×2 cm) and spin coated with a spin coater (Institute of Electronics, Chinese Academy of Sciences, model: kW-4A) at 2000 r/min 60 s at room temperature to obtain a solid substance of GO and ruthenium nitrate on the PVC membrane. This solid substance is put in an autoclave with a hydrogen atmosphere and reacts at 5 MPa hydrogen pressure and 25° C. 12 h to obtain a graphene based conductive material with conductive layer 20 nm thick. According to the calculation based on the added materials, in the graphene based conductive material, the ratio between the metal atoms in the conductive layer and the carbon atoms in the GO is 0.04, the content of graphene is 64 wt %, the content of metal ruthenium is 15 wt % and the content of water and impurities is 21 wt %. The resistivity of the conductive layer of the obtained graphene based conductive material measured by a four-point-probe resistance tester (Guangzhou Four-Probe Instruments Co., Ltd., model: RTS-9 double-electrometric four-point-probe tester) is 2 kΩ/sq. The light transmittance at 550 nm is 76%. The graphene based conductive material has both light transmittance and electrical conductivity, so it can be used a material of window electrodes.

### Example 8

This example is intended to describe the preparation method of the graphene based conductive material of the present invention.
(1) Preparation of a GO colloidal solution: Same as Step (1) in Example 1.
(2) Preparation of a graphene based conductive material: 1 ml of iridium nitrate aqueous solution (2 g/l as to iridium, Beijing Chemical Reagent Co., Ltd.) is added to 60 ml of the GO colloidal solution obtained by the above Step (1) (containing about 60 mg of GO). 0.4 ml of the obtained mixed solution is dropwise added on a cleaned PET membrane (2 cm×2 cm) and spin coated with a spin coater (Institute of Electronics, Chinese Academy of Sciences, model: kW-4A) at 2000 r/min 60 s at room temperature to obtain a solid substance of GO and iridium nitrate on the PET membrane. The solid substance is put in an autoclave with a hydrogen atmosphere and reacts at 5 MPa hydrogen pressure and 25° C. 5 d to obtain a graphene based conductive material with conductive layer 16 nm thick. According to the calculation based on the added materials, in the graphene based conductive material, the ratio between the metal atoms in the conductive layer and the carbon atoms in the GO is 0.002, the content of graphene is 93.2 wt %, the content of metal iridium is 2.5 wt % and the content of water and impurities is 4.3 wt %. The resistivity of the conductive layer of the obtained graphene based conductive material measured by a four-point-probe resistance tester (Guangzhou Four-Probe Instruments Co., Ltd., model: RTS-9 double-electrometric four-point-probe tester) is 2.5 kΩ/sq. The light transmittance at 550 nm is 82%. This graphene based conductive material has both light transmittance and electrical conductivity, so it can be used a material of window electrodes.

### Example 9

This example is intended to describe the preparation method of the graphene based conductive material of the present invention.
(1) Preparation of a GO colloidal solution: Same as Step (1) in Example 1.
(2) Preparation of a graphene based conductive material: 0.3 ml of rhodium chloride (RhCl₃) aqueous solution (2 g/l as to Rh, Beijing Chemical Reagent Co., Ltd.) is added to 60 ml of the GO colloidal solution obtained by the above Step (1) (containing about 60 mg of GO). 2.5 ml of the obtained mixed solution is dropwise added on a cleaned PET membrane (2 cm×2 cm). The sheet with the solution is dried at 80° C. to obtain a solid substance of GO and RhCl₃ on the PET membrane. The solid substance is put in an autoclave with a hydrogen atmosphere and reacts at 5 MPa hydrogen pressure and 25° C. 12 h. Through HF treatment, a stand-alone graphene based conductive material with conductive layer 2.5 μm thick is obtained. According to the calculation based on the added materials, in the graphene based conductive material, the ratio between the metal atoms in the conductive layer and the carbon atoms in the GO is 0.004, the content of graphene is 92.2 wt %, the content of metal rhodium is 2.7 wt % and the content of water and impurities is 5.1 wt %. The resistivity of the conductive layer of the obtained graphene based conductive material measured by a four-point-probe resistance tester (Guangzhou Four-Probe Instruments Co., Ltd., model: RTS-9 double-electrometric four-point-probe tester) is 80 Ω/sq.

### Example 10

This example is intended to describe the preparation method of the graphene based conductive material of the present invention.
(1) Preparation of a GO colloidal solution: Same as Step (1) in Example 1.
(2) Preparation of a graphene based conductive material: 3.5 ml of Osmium chloride (OsCl₄) aqueous solution (2 g/l as to Os, Beijing Chemical Reagent Co., Ltd.) is added to 60 ml of the GO colloidal solution obtained by the above Step (1) (containing about 60 mg of GO). 2 ml of the obtained mixed solution is dropwise added on a cleaned PET membrane (2 cm×2 cm). The sheet with the solution is dried at 80° C. to obtain a solid substance of GO and OsCl₄ on the PET membrane. This solid substance is put in an autoclave with a hydrogen atmosphere and reacts at 5 MPa hydrogen pressure and 25° C. 12 h to obtain a graphene based conductive material with conductive layer about 2 μm thick. According to the calculation based on the added materials, in the graphene based conductive material, the ratio between the metal atoms in the conductive layer and the carbon atoms in the GO is 0.014, the content of graphene is 87.3 wt %, the content of metal osmium is 9 wt % and the content of water and impurities is 3.7 wt %. The resistivity of the conductive layer of the obtained graphene based conductive material measured by a four-point-probe resistance tester (Guangzhou Four-Probe Instruments Co., Ltd., model: RTS-9 double-electrometric four-point-probe tester) is 10 Ω/sq.

### Example 11

This example is intended to describe the preparation method of the graphene based conductive material of the present invention.
(1) Preparation of a GO colloidal solution: Same as Step (1) in Example 1.
(2) Preparation of a platinum colloidal nano particle solution: 50 ml of 7.4 g/l chloroplatinic acid glycol solution is added to 50 ml of glycol solution containing 1.04 g of NaOH. After 30 min's stirring, the mixture reacts at 180° C. under the protection of nitrogen 3 h. After cooling, a platinum colloidal nano particle solution (3.7 g/l as to Pt, Beijing Chemical Reagent Co., Ltd.) is obtained. The range of the size of platinum colloid is 0.7-3.5 nm.
(3) Preparation of a graphene based conductive material: 1 ml of the platinum colloidal nano particle solution obtained in the foregoing Step (2) (3.7 g/l as of Pt, Beijing Chemical Reagent Co., Ltd.) is added to 60 ml of the GO colloidal solution obtained by the above Step (1) (containing about 60 mg of GO). 2 ml of the obtained mixed solution is dropwise added on to a cleaned mica sheet (2 cm×2 cm). The sheet with the solution is dried at 80° C. to obtain a solid substance of GO and platinum colloidal nano particles on the mica sheet. This solid substance is put in an autoclave with a hydrogen atmosphere and reacts at 5 MPa hydrogen pressure and 25° C. 12 h to obtain a graphene based conductive material with conductive layer 2 μm thick. According to the calculation based on the added materials, in the graphene based conductive material, the ratio between the metal atoms in the conductive layer and the carbon atoms in the GO is 0.007, the content of graphene is 91 wt %, the content of metal platinum is 5.6 wt % and the content of water and impurities is 3.4 wt %. The resistivity of the conductive layer of the obtained graphene based conductive material measured by a four-point-probe resistance tester (Guangzhou Four-Probe Instruments Co., Ltd., model: RTS-9 double-electrometric four-point-probe tester) is 35 Ω/sq.

### Example 12

This example is intended to describe the preparation method of the graphene based conductive material of the present invention.
(1) Preparation of a GO colloidal solution: Same as Step (1) in Example 1.
(2) Preparation of ruthenium colloid: 1 g of RhCl₃.6H₂O (Beijing Chemical Reagent Co., Ltd.) is dissolved in 50 ml of water. 3 g of polyvinyl pyrrolidone (average molecular weight, 40000, Beijing Chemical Plant) is added. The solution is heated and reflowed 6 h to obtain a colloidal solution of ruthenium. The concentration of the solution is 6.4 g/l (as to ruthenium) and the range of the size of ruthenium colloidal particles is 2.5-10 nm.
(3) 0.54 ml of the ruthenium colloid (6.4 g/l as to ruthenium, Beijing Chemical Reagent Co., Ltd.) obtained in Step (2) is added to 60 ml of the GO colloidal solution obtained by the above Step (1) (containing about 60 mg of GO). 0.5 ml of isopropanol is added to the obtained mixed solution. After evenly mixed, the obtained mixed solution is injected to the ink box (HP816) of an ink jet printer. A HP printer (HP2468) is used to print on paper 20 times to obtain an expected pattern. The substance obtained on the printing paper is put in an autoclave with a hydrogen atmosphere and reacts at 5 MPa hydrogen pressure and 25° C. 12 h to obtain a graphene based conductive material with a pattern. The conductive layer is 20 μm thick (refer to FIG. 3). The content of graphene in the conductive layer of this conductive material is 60 wt %, the content of ruthenium is 5 wt % and the content of other impurities is 35 wt %. The resistivity of the conductive layer of the obtained graphene based conductive material measured by a four-point-probe resistance tester (Guangzhou Four-Probe Instruments Co., Ltd., model: RTS-9 double-electrometric four-point-probe tester) is 8 Ω/sq.

What is claimed is:

1-18. (canceled)

19. A method for preparing a graphene based conductive material, characterized in that the method includes: preparing a solid film on a substrate layer by using graphene oxide sol and metal salt solution and/or metal colloidal solution, keeping the solid film separated or without separated from the substrate layer standing for from 30 s to 10000 h in an atmosphere consisting of hydrogen or containing hydrogen at temperature of −50° C.˜200° C. under hydrogen pressure of 0.01-100 MPa, obtaining a graphene based conductive material.

20. The method according to claim 19, wherein the time of standing is from 5 min to 300h.

21. The method according to claim 20, wherein the time of standing is from 2 h to 5 days.

22. The method according to claim 19, wherein the hydrogen pressure is 0.2-100 MPa.

23. The method according to claim 19, wherein the ratio between the metal atoms in the graphene based conductive material and the carbon atoms in the graphene is 0.0001-0.13, the diameter of the colloidal particles in the metal colloidal solution is 0.7-10 nm, the concentration of the graphene oxide sol is 0.5-2 g/L, the concentration of the metal salt solution is 1-3 g/L, and the concentration of the metallic colloid is 3-7 g/L.

24. The method according to claim 19, wherein the metal in the metal salt solution and/or metal colloidal solution is one or more selected from the group consisting of palladium, platinum, rhodium, ruthenium, osmium, iridium and nickel, the metal salt is one or more selected from the group consisting of nitrate, hydrochloride, sulfate, phosphate, oxalate, acetate, formate, propionate, butyrate and valerate, the solvent of the metal salt solution is one or more selected from the group consisting of water, C1-C4 low alcohols, acetone and dimethyl formamide, and the solvent of the graphene oxide sol is one or more selected from the group consisting of water, C1-C4 low alcohols and acetone.

25. The method according to claim 19, wherein the preparing a solid film on a substrate layer by using graphene oxide sol and metal salt solution and/or metal colloidal solution includes one or more processes selected from the group consisting of spin coating process, droplet coating process, spray coating process, inkjet printing process and a process of heating the liquid films into solid films.

26. The method according to claim 19, wherein the material of the substrate layer is one of glass sheet, quartz sheet, silicon slice, silicon carbide sheet, fibrous flexible material, natural flexible ore material and polymer membrane.

27. The method according to claim 26, wherein the polymer membrane is a transparent film made from polyethylene terephthalate, polyethylene, polypropylene, polystyrene or polyvinyl chloride, the fibrous flexible material is printing paper, and the natural flexible ore material is mica sheet.

28. A graphene based conductive material, characterized in that the graphene based conductive material is prepared by the method in claim 19.

29. The graphene based conductive material according to claim 28, wherein the graphene based conductive material comprises a conductive layer, the conductive layer contains metal and graphene, the resistivity of the conductive layer is 0.01 Ω/sq-50 kΩ/sq, the light transmittance is 0-96% and the thickness is 1 nm-1 mm.

30. The graphene based conductive material according to claim 29, wherein the light transmittance is 0-90% and the thickness is 5 nm-1 mm.

31. The graphene based conductive material according to claim 29, wherein the resistivity of the conductive layer is 100 Ω/sq-50 kΩ/sq, the light transmittance is 50-90% and the thickness is 1-100 nm; or the resistivity of the conductive layer is 0.01-100 Ω/sq and the thickness is 100 nm-1 mm.

32. The graphene based conductive material according to claim 29, wherein on the basis of the total amount of the conductive layer, the content of graphene in the conductive layer is 60-99.999 wt % and the content of metal is 0.001-40 wt %.

33. The graphene based conductive material according to claim 29, wherein the conductive layer also contain water and impurities, on the basis of the total amount of the conductive layer, the content of graphene in the conductive layer is 64-98 wt %, the content of metal is 1-15 wt %, and the total content of water and impurities is 0-35 wt %.

34. The graphene based conductive material according to claim 29, wherein the graphene based conductive material also comprises a substrate layer to which the conductive layer is attached.

35. The graphene based conductive material according to claim 34, wherein the material of the substrate layer is one of glass sheet, quartz sheet, silicon slice, silicon carbide sheet, fibrous flexible material, natural flexible ore material and polymer membrane.

36. The graphene based conductive material according to claim 35, wherein the polymer membrane is a transparent film made from polyethylene terephthalate, polyethylene, polypropylene, polystyrene or polyvinyl chloride, the fibrous flexible material is printing paper, and the natural flexible ore material is mica sheet.

37. A graphene based conductive material, characterized in that the graphene based conductive material is prepared by the method in claim 21.

38. A graphene based conductive material, characterized in that the graphene based conductive material is prepared by the method in claim 22.
